(19) United States
(12) Patent Application Publication
(10) Pub. No.: US 2008/0100468 A1
(43) Pub. Date: May 1, 2008

(54) DISTANCE REMINDER APPARATUS AND REMINDER METHOD

(75) Inventor: FENG XU, Shenzhen (CN)

Correspondence Address: PCE INDUSTRY, INC.;ATT. CHENG-JU CHIANG J, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION CO., LTD., Tu-Cheng (TW)

(21) Appl. No.: 11/857,450

(22) Filed: Sep. 19, 2007

(30) Foreign Application Priority Data
Oct. 27, 2006 (CN) 200610201039.5

(51) Int. Cl. G05B 7/00

(52) U.S. Cl. 340/691.1

(57) ABSTRACT

A distance reminder apparatus includes a detector module, a processor module, an alarm circuit, and a clock circuit. The detector module is used for detecting a user, and generating a detect signal accordingly. The processor module is used for generating a drive signal according to the detect signal. The clock circuit is used for providing a clock signal to the processor module, the processor module begins counting according to the clock signal when the detect signal indicates the user is within a predetermined distance. The drive signal generated by the processor module drives the alarm circuit to activate a indicator when a predetermined amount of time has elapsed.

### BACKGROUND

1. Field of the Invention

The present invention relates to a reminder apparatus and related reminder method. Particularly, the present invention relates to a distance reminder apparatus and a related distance reminder method for a display.

2. Description of related art

Computers have monitors to display information to users. When looking at the monitors, there should be an optimal distance between the monitors and users' eyes, so that the users' eyes are less likely to be fatigued or damaged.

However, people often move too close to the display, and may thus hurt their eyes after looking at the display for a long time. Consequently, an apparatus capable of reminding users to maintain a safe distance from a monitor is needed in the industry.

### SUMMARY

In one embodiment, a distance reminder apparatus includes a detector module, a processor module, an alarm circuit, and a clock circuit. The detector module is used for detecting a user, and generating a detect signal accordingly. The processor module is used for generating a drive signal according to the detect signal. The clock circuit is used for providing a clock signal to the processor module, the processor module begins timing according to the clock signal at the moment the detect signal indicates the user is within a predetermined distance. The drive signal generated by the processor module activates the alarm circuit for alerting the user after a predetermined amount of time has elapsed.

Other advantages and novel features of the present distance reminder apparatus and related distance reminder method will become more apparent from the following detailed description of an embodiment when taken in conjunction with the accompanying drawings, in which:

### BRIEF DESCRIPTION OF THE DRAWINGS

FIG. 1 is a block diagram of a distance reminder apparatus according to an exemplary embodiment;

FIG. 2 is a schematic circuit diagram of the distance reminder apparatus of FIG. 1; and

FIG. 3 is a flow chart of a distance reminder method according to an exemplary embodiment.

### DETAILED DESCRIPTION

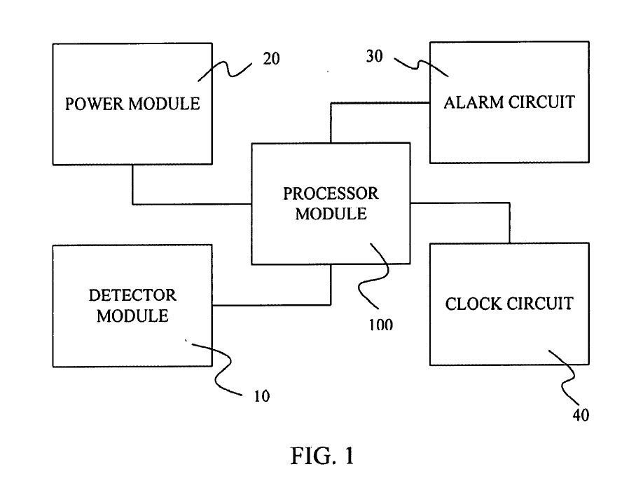

Referring to FIG. 1, a distance reminder apparatus according to an exemplary embodiment includes a detector module 10, a power module 20, a clock circuit 40, a processor module 100, and an alarm circuit 30. In the embodiment, the processor module 100 is a single chip microprocessor HT48.

The detector module 10 is used for detecting the presence of users, and generating a detect signal according to the detection. In this embodiment, the detector module 10 includes an infrared detector. The infrared detector is aimed at an area where the user is considered to be within a minimum optimal distance from the display. For example, if the distance is set to be 70 centimeters, and the user is located within that distance of the front of the monitor, the infrared detector would generate a high level detect signal, otherwise the detect signal stays at a low level. The detector module 10 transmits the detect signal to the processor module 100.

The power module 20 is connected with a power supply (not shown), and the processor module 100, for powering the processor module 100, and providing a reset signal for the processor module 100.

The clock circuit 40 is used for generating a clock signal. The clock circuit 40 sends the clock signal to the processor module 100.

The processor module 100 is connected with the detector module 10 and the clock circuit 40. The processor module 100 receives the detect signal, and generates a drive signal according to the detect signal. The processor module 100 outputs a high level drive signal if the detect signal stays at a high level for a predetermined period of time, clocked by the clock signal, or the processor module 100 outputs a low level drive signal if the low level detect signal is received. The processor module 100 sends the drive signal to the alarm circuit 30.

The alarm circuit 30 is used for alerting users if they are too close to the monitor for the predetermined time. If the alarm circuit 30 receives the high level drive signal, an indicator such as a buzzer or light (not shown) in the alarm circuit 30 is activated. If the alarm circuit 30 receives the low level drive signal, the alarm circuit 30 remains inactive.

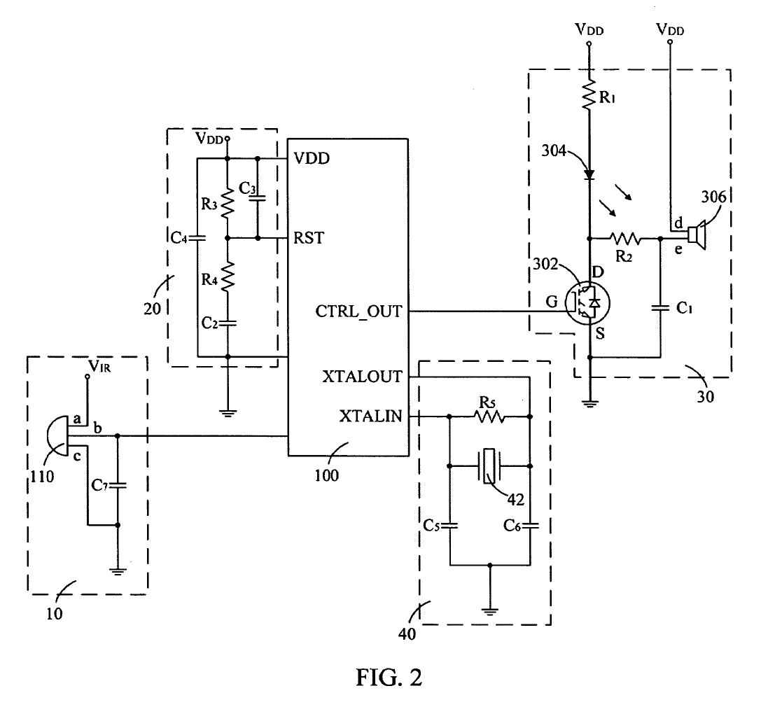

Referring to FIG. 2, a schematic circuit diagram of the distance reminder apparatus is illustrated. The detector module 10 includes an infrared detector 110, a voltage supplier V_{IR}, and a coupling capacitor C₇. The voltage supplier V_{IR} is connected to a first pin a, of the infrared detector 110, for providing a work voltage to the infrared detector 110. A second pin c, of the infrared detector 110, is connected to ground. The infrared detector 110 generates the detect signal according to the detection, and sends out the detect signal to the processor module 110 through a third pin b. The third pin b, of the infrared detector, is also coupled to ground through the coupling capacitor C₇. Alternatively, the infrared detector 110 can be replaced by other detectors, such as ultrasonic detector, etc.

The power module 20 includes a power supply V_{DD}, two resistors R₃ and R₄ connected in series, and three coupling capacitors C₂, C₃, and C₄. The power supply V_{DD} is connected to ground through the two resistors R₃, R₄, and the coupling capacitor C₂ in turn. The coupling capacitor C₃ is connected in parallel with the resistor R₃, with its two ends connected to pins VDD and RST of the processor module 110, respectively. The coupling capacitor C₄ is connected between the power supply V_{DD} and ground. The two resistors R₃ and R₄ divide a voltage of the power supply V_{DD}, and provide a proper work voltage to the processor module 100. In other embodiments, if the processor module 100 requires a different work voltage, different power supplies V_{DD} and adjustable resistors R₃, R₄ can be employed.

The clock circuit 40 includes a crystal oscillator 42, a resistor R₅, and two coupling capacitors C₅, C₆. Two ends of the crystal oscillator 42 are connected to pins XTALOUT and XTALIN of the processor module 100, respectively, for providing the clock signal for the processor module 100. The resistor R₅ is connected in parallel with the crystal oscillator 42. The two coupling capacitors C₅ and C₆ are respectively connected to two ends of the crystal oscillator 42 and ground.

The alarm circuit 30 includes a switch unit 302, a light 304, and a buzzer 306. The switch unit 302 is connected to pin CTRL_OUT of the processor module 100. The switch unit 302 is switched on or off according to the drive signal output from the processor module 100. The switch unit 302 may be a Bipolar Junction Transistor (BJT), a Field Effect Transistor (FET), or an Insulated Gate Bipolar Transistor (IGBT), each of which has a source, a gate, and a drain. The source of the switch unit 302 is connected to ground, the gate of the switch unit 302 is connected to the output (pin CTRL_OUT) of the processor module 100, and the drain is connected with the light 304 and the buzzer 306.

The light 304 can be a Light Emitting Diode (LED), an anode of the light 304 is connected to the power supply V_{DD} through a first resistor R₁, and a cathode of the light 304 is connected with the drain of the switch unit 302. Similarly, a first end of the buzzer 306 is connected to the power supply V_{DD}, a second end of the buzzer 306 is connected with the drain of the switch unit 302 through a second resistor R₂. The second end of the buzzer 306 is also coupled to ground through a coupling capacitor C₁.

If the high level drive signal is transmitted to the gate of the switch unit 302 from the pin CTRL_OUT of the processor module 100, the switch unit 302 is turned on. The drain of the switch unit 302 has a high voltage level, thus the light 304 emits light, and the buzzer 306 beeps. If the low level drive signal is received by the gate of the switch unit 302, the switch unit 302 is turned off, thus the drain of the switch unit 302 has a high voltage level, the light 304 is not lit and the buzzer 306 keeps silent.

In use, the detector module 10 of the distance reminder apparatus is fixed on or near the display. If the detector module 10 detects the user in front of the monitor within the predetermined distance, a counter in the processor module 100 starts to count according to the clock signal sent from the clock circuit 40. When a predetermined amount of time has elapsed, the processor module 100 outputs the high level drive signal. During counting, if the detect signal no longer indicates that the user is no longer within the predetermined distance, the counter is reset.

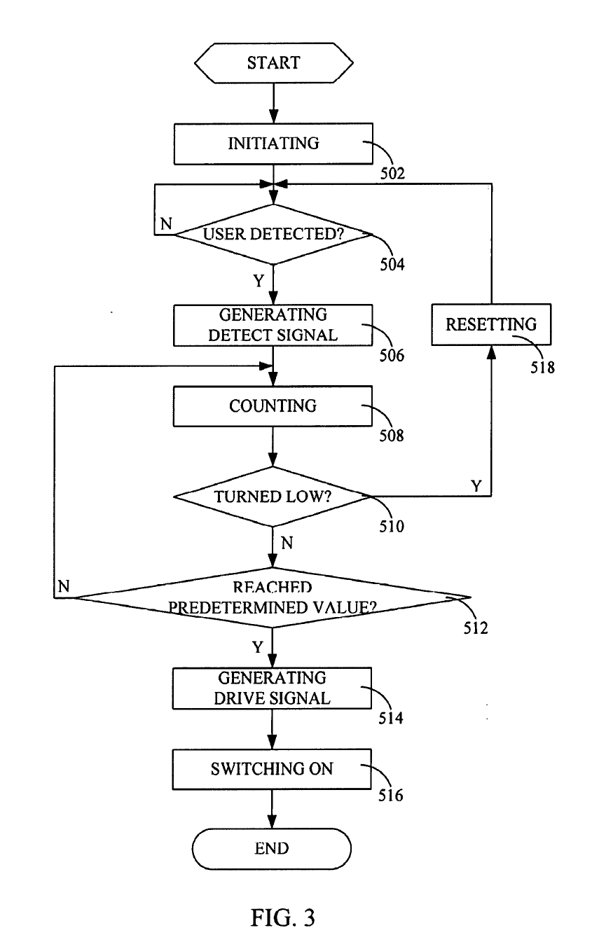

Referring to FIG. 3, a flow chart of a distance reminder method for a monitor is illustrated. The distance reminder apparatus is incorporated as an example in below description of the distance reminder method.

Step 502, the reminder apparatus is activated, the voltage supplier V_{IR} supplies a work voltage to the infrared detector 110 of the detector module 10, the power module 20 provides power for the processor module 100.

Step 504, the infrared detector 110 in the detector module 10 detects if the user is within a predetermined distance of the front of the monitor, and generates a detect signal according to the detection.

If the infrared detector 110 detects no user in front of the monitor within the predetermined distance, the detector module 10 generates a low level detect signal, and step 504 is repeated.

Step 506, if, in step 504, the infrared detector 110 detects that there is a user in front of the monitor within the predetermined distance, a high level detect signal is generated and sent to the processor module 100.

Step 508, on receiving the high level detect signal, the counter in the processor module 100 begins to count according to the clock signal sent from the clock circuit 40.

Step 510, the processor module 100 determines whether the detect signal has turned from high level to low level.

Step 512, if it is concluded in the step 510 that the detect signal has not turned low, the processor module 100 determines whether the counter has reached the predetermined value. If the counter has not reached the predetermined value, the procedure goes to the step 508.

Step 514, if it is concluded in the step 512 that the counter has reached the predetermined value, the processor module 100 generates a high level drive signal, and sends the drive signal to the alarm circuit 30.

Step 516, the switch unit 302 is switched on when the high level drive signal is received. The light 304 is lit, and the buzzer 306 beeps, accordingly.

Step 518, if it is concluded in the step 510 that the detect signal has turned low, the processor module 100 resets the counter, and the procedure goes to the step 504.

The reminder apparatus and the related reminder method detects if there is a user in front of the monitor within a predetermined distance, and alerts when the user is located in the predetermined distance. By incorporating this, the monitor provides protection for user's eyes.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A distance reminder apparatus comprising:
a detector module for detecting a user, and generating a detect signal accordingly;
a processor module for generating a drive signal according to the detect signal; an alarm circuit; and
a clock circuit for providing a clock signal to the processor module, the processor module begins timing according to the clock signal if the detect signal indicates the user is within a predetermined distance; wherein
the drive signal generated by the processor module activates the alarm circuit when a predetermined amount of time has elapsed.

2. The distance reminder apparatus as described in claim 1, wherein the detector module comprises an infrared detector, the infrared detector being capable of detecting the presence of the user within the predetermined distance.

3. The distance reminder apparatus as described in claim 1, further comprising a power module for providing power to the processor module.

4. The distance reminder apparatus as described in claim 3, wherein the power module is configured for resetting the processor module.

5. The distance reminder apparatus as described in claim 1, wherein the alarm circuit comprising a switch unit, a power supply, and an alert unit connected in series, the drive signal switches on the switch unit if the processor module has counted for the predetermined amount of time.

6. The distance reminder apparatus as described in claim 5, wherein the alert unit is a light.

7. The distance reminder apparatus as described in claim 5, wherein the alert unit is a buzzer.

8. The distance reminder apparatus as described in claim 5, wherein the switch unit is an insulated gate bipolar transistor.

9. A monitor comprising a distance reminder apparatus, the distance reminder apparatus comprising:
a detector module fixed on the monitor, for detecting a user at the front of the monitor, and generating a detect signal accordingly;
an alarm circuit; and
a processor module for activating the alarm circuit to give out alert when the detect signal indicates that the user is located within a predetermined distance of the front of the monitor for a predetermined time.

10. The monitor as described in claim 9, further comprising a clock circuit for providing a clock signal for the processor module, the processor module drives the alarm circuit to activate an indicator when the detect signal has sustained for the predetermined time indicating that the user is located within the predetermined distance.

11. The monitor as described in claim 9, wherein the processor module is configured for generating a drive signal, and sending the drive signal to the alarm circuit.

12. The monitor as described in claim 11, wherein the alarm circuit comprises:
a power supply for providing power;
an alert unit as the indicator; and
a switch unit for selectively switching on the alert unit according to the drive signal.

13. The monitor as described in claim 12, wherein the alert unit is a light.

14. The monitor as claimed in claim 12, wherein the alert unit is a buzzer.

15. The monitor as claimed in claim 12, wherein the switch unit is an insulated gate bipolar transistor.

16. A distance reminder method, comprising steps of:
detecting a user;
determining if the user is located within a predetermined distance according to the detection;
activating an indicator if the user is located within the predetermined distance for a predetermined time.

17. The distance reminder method as described in claim 16, further comprising: begin counting if the user is detected to be located within the predetermined distance.

18. The distance reminder method as described in claim 16, further comprising steps of:
sending out a drive signal according to the detection;
switching on an indicator according to the drive signal.
